(19) United States
(12) Patent Application Publication
(10) Pub. No.: US 2003/0200670 A1
(43) Pub. Date: Oct. 30, 2003

(54) Multifunction acoustic/audio assistant

(76) Inventor: Bing Ren Ching, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/128,277

(22) Filed: Apr. 24, 2002

(51) Int. Cl. G01B 3/14

(52) U.S. Cl. 33/562; 33/263; 33/483

(57) ABSTRACT

A multifunction acoustic/audio assistant includes a hand-held device body, a ruler, and all observation device. A rear side of the hand-held device body is provided with a measure face defined thereon to measure an intersection angle of microphones. The ruler is mounted onto a side face of the hand-held device body proximate to the measure face in order to measure the distance between the respective diaphragms of the microphones. The observation device is mounted onto the hand-held device body to determine the sound dispersion area and remotely observe distant events. The different tools demanded by an acoustic/audio specialist are thus integrated into the hand-held device.

### BACKGROUND OF THE INVENTION

1. Field of the Invention

The present invention relates to a multifunction acoustic assistant. More particularly, the invention provides an acoustic/audio assistant tool that is constructed from a peripheral component device.

2. Description of the Related Art

Hand-held electronic devices such as personal digital assistants (PDA) or pocket personal computers become increasingly popular. Typical hand-held electronic devices are usually multifunction by providing the functions of personal data storage, organizer, scheduler, event memory, electronic dictionary, stock live reporting, and other information transmission and service functions. Provided with such a hand-held electronic device, the user can dispose information in real time and have a better control of available resources. Moreover, as the dimensions of hand-held electronic devices are reduced, they can be also conveniently used in combination with other peripheral component devices such as touch stylus, keyboard, or camera, thereby diversifying their utilization.

However, the conventional hand-held electronic devices yet are not equipped with some basic acoustic/audio tools for specific uses as described hereafter.

In stereophonic acoustics, the so-called “Office de Radiodiffusion Television Francaise” (ORTF) that is a well-known Stereo Microphone set-up developed by the French Organiztion in the broadcasting and television. As illustrated in FIG. 1, this method is similar to a method of X-Y sound reception, in which two microphones 1a are outwardly oriented 110 degrees, and at a distance of about 17 cm. Because the distance between the microphones 1a is not substantial, the degree of phase deterioration is not excessive. This configuration is thus most popular for Stereo recording.

The sound dispersion area from the speakers has to be determined by means of an observer. Moreover, a telescope is usually needed to observe the events on the stage from a distant. A specific tool that enables the specialist to perform the above sound system tasks is thus needed.

### SUMMARY OF THE INVENTION

It is therefore a principal object of the invention to provide a multifunction acoustic/audio assistant that can be constructed from a hand-held electronic device.

To accomplish the above and other objectives, a multifunction acoustic/audio assistant comprises a hand-held device body, a ruler, and an observation device. A rear side of the hand-held device body is provided with a measure face defined thereon to measure an intersection angle of microphones. The ruler is mounted onto a side face of the hand-held device body proximate to the measure face in order to measure the distance between the diaphragms diaphragms of the microphones. The observation device is mounted onto the hand-held device body to determine the sound dispersion area and remotely observe distant events.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a farther understanding of the invention. A brief introduction of the drawings is as follows:

FIG. 1 is a schematic view illustrating the configuration of microphones according to the ORTF method.

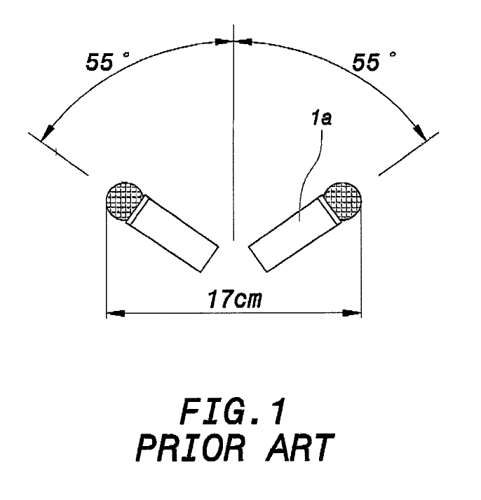

FIG. 2 is a perspective view of a multifunction acoustic/audio assistant according to an embodiment of the invention.

FIG. 3 is a perspective view showing a rear side of the multifunction acoustic/audio assistant of FIG. 2

FIG. 4 is a perspective view illustrating utilization of the multifunction acoustic/audio assistant according to an embodiment of the invention.

FIG. 5 is a schematic view showing an interior of an observer of the multifunction acoustic/audio assistant.

### DETAILED DESCRIPTION OF THE EMBODIMENTS

Wherever possible in the following description, like reference numerals will refer to like elements and parts unless otherwise illustrated.

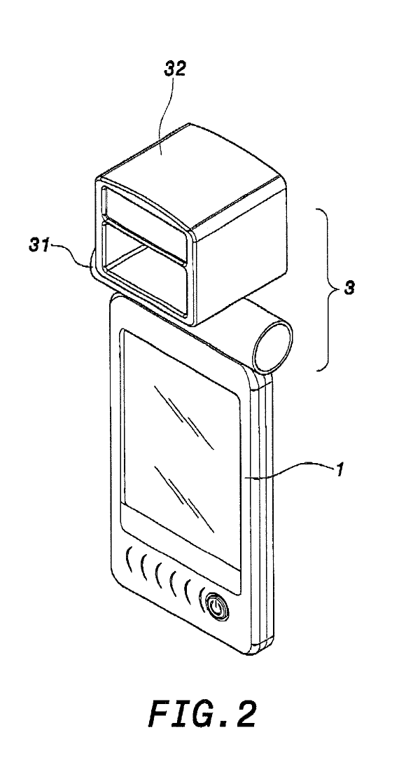

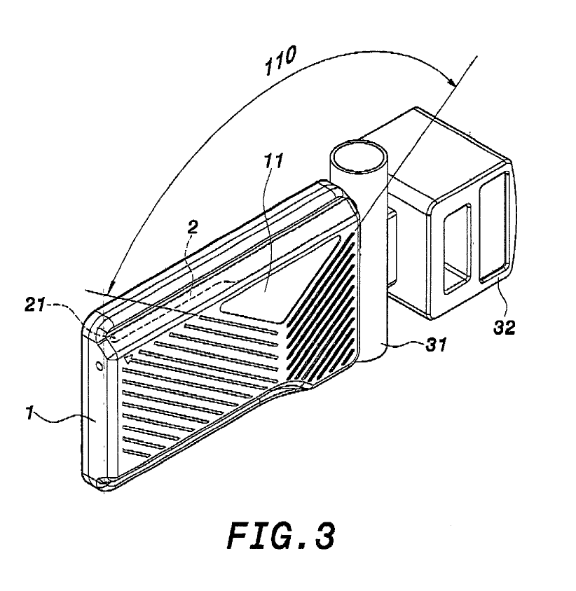

Referring to FIG. 2 and FIG. 3, two perspective views illustrate a multifunction acoustic/audio assistant according to an embodiment of the invention. As shown in FIG. 2 and FIG. 3, the acoustic/audio assistant comprises a hand-held device body 1, a ruler 2, and an observation device 3.

The hand-held device body 1 can be, for example, a personal digital assistant (PDA) or a pocket personal computer. A measure face 11, approximately triangular, is formed on a rear side of the hand-held device body 1. The measure face 11 defines an intersection angle of 110 degrees.

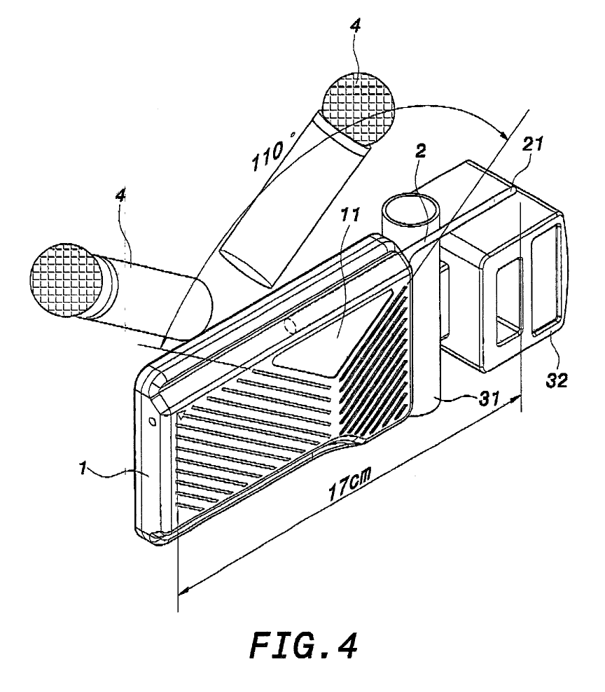

The ruler 2 is mounted to a side face of the hand-held device body 1, and is proximate to the measure face 11. The ruler 2 can be used as a touch stylus for item selection on a display panel of the hand-held device body 1. The ruler 2 has an end formed with a touch contact terminal 21 that can be mounted inwardly or outwardly with reference to the hand-held device body 1. Moreover, the touch contact terminal 21 is outwardly mounted with reference to the hand-held device body 1, and a distance between the touch contact terminal 21 and an opposite end of the hand-held device body 1 is at least 17 cm (see FIG. 4).

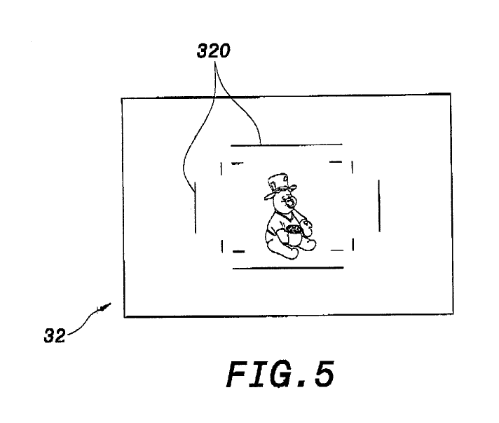

The observation device 3 comprises a telescope 31 and an observer 32. The telescope 31 is mounted onto the hand-held body 1, while the observer 32 is mounted onto the telescope 31. It would be readily appreciated that other configuration of the telescope 31 and the observer 32 may be also adequate in the invention. An internal part of the observer 32 is provided with frame lines 320 (see FIG. 5),

Referring to FIG. 4, a perspective view illustrates utilization of the measure face 11 and the ruler 2 according to an embodiment of the invention. According to the ORTF method, by means of the measure face 11, microphones 4 are placed in a manner to define an intersection angle of 110 degrees therebetween. The ruler 2 is further mounted and serves as a measure means for setting a distance of 17 cm between the diaphragms of the microphone 4. The microphones 4 preferably have good stereophonic effects,

Via the observer 32, the user can observe the dispersion angle of each speaker, and directly from the location of the speaker, determine the sound dispersion area. Moreover, by means of the telescope 31, the user can remotely observe various events that take place on, for example, a stage.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A multifunction acoustic/audio assistant comprising:
a hand-held device body, having a rear side defining a measure face for measuring an intersection angle between two microphones;
a ruler, mounted onto a side of the hand-held device body and adjacent to the measure face for measuring a distance between respective diaphragms of the two microphones; and
an observation device, mounted onto the hand-held device body to determine a sound dispersion area and remotely observe distant events.

2. The multifunction acoustic/audio assistant of claim 1, wherein the hand-held device body is a personal digital assistant or a pocket personal computer.

3. The multifunction acoustic/audio assistant of claim 1, wherein the ruler has a touch contact terminal at an end thereof.

4. The multifunction acoustic/audio assistant of claim 3, wherein the touch contact terminal of the ruler is inwardly or outwardly mounted with reference to the hand-held device body.

5. The multifunction acoustic/audio assistant of claim 3, wherein the touch contact terminal is outwardly mounted with reference to the hand-held device body, and a distance between the touch contact terminal and an opposite end of the hand-held device body is preferably 17 cm.

6. The multifunction acoustic/audio assistant of claim 1, wherein the measure face has an intersection angle being preferably 110 degrees.

7. The multifunction acoustic/audio assistant of claim 1, wherein the observation device includes a telescope and an observer being connected with the telescope.

8. The multifunction acoustic/audio assistant of claim 7, wherein the observer has a plurality of frame lines on an interior thereof.
